(19) United States
(12) Patent Application Publication
(10) Pub. No.: US 2011/0195599 A1
(43) Pub. Date: Aug. 11, 2011

(54) FLAT RESTORABLE CABLE

(75) Inventors: Lien-Hsun HO, Taipei (TW); Hsiung-Kuei CHENG, Taipei (TW)

(73) Assignee: CYBER POWER SYSTEM INC., Taipei (TW)

(21) Appl. No.: 12/701,530

(22) Filed: Feb. 6, 2010

(51) Int. Cl. H01R 12/24

(52) U.S. Cl. 439/492

(57) ABSTRACT

A flat restorable cable has a cable body and two connectors. The cable body is wound to have a spirally wound form. The cable body is extended by pulling two ends of the cable, and restores back to the original spirally wound form once either end of the cable is released. The two connectors are securely mounted to respective ends of the cable body and used to respectively connect with two external compatible interfaces. As a result of less part required, compact size and thin thickness, the flat restorable cable addresses an inexpensive and portable solution to connect two electronic devices over a short distance.

### BACKGROUND OF THE INVENTION

1. Field of the Invention

The present invention is related to a cable, and more particularly to a flat restorable cable capable of restoring back to its spirally wound shape after the use for connecting two electronic devices over a short distance.

2. Description of the Related Art

Physical connection between two electronic devices usually relies on a cable or a wire connected therebetween. Although physical connection is more reliable than wireless connection, the cable or wire should be always available by the time a connection is required. When the physical connection is not required, the cable or wire should be disconnected and stored well in order not to be messy and get passers-by stumbled.

The storage issue opens the door to retractable cables or cable retractors. With reference to FIGS. 5 and 6, a conventional single-direction retractable cable has a housing (6), a winding unit (7) and a line unit (8). The housing (6) has a center shaft (61) penetrating through the winding unit (7). The winding unit (7) is received in the housing (6) and has a rotary disk (71) and a coil spring (72). The coil spring (72) is mounted on the center shaft (61) and the rotary disk (71). The line unit (8) has a first cable (81) and a second cable (82). The first cable (81) penetrates through the winding unit (7) and the housing (6), and is wound around a periphery of the winding unit (7). The second cable (82) is connected with the first cable (81), is wound around the center shaft (61), and penetrates through the housing (6). The first cable (81) can be pulled out to connect with first electronic equipment. Since the first cable (81) and the second cable (82) are connected, the second cable (82) can be connected to second electronic equipment to communicate with the first electronic equipment.

With reference to FIG. 7, a telephone handset cord serving to connect a telephone handset and a telephone base has a cable (91) and two plugs (92). The cable (91) takes a helical form. The two plugs (92) are securely mounted to both ends of the cable (91).

The above-mentioned conventional retractable cable and the telephone handset cord are still too large and thick to be carried in a pocket of a shirt or a paint. Especially, the conventional retractable cable involves with more parts and inevitably makes it more expensive. In terms of size and cost reduction, conventional retractable cable and the telephone handset cord need to be further refined.

### SUMMARY OF THE INVENTION

An objective of the present invention is to provide a flat restorable cable addressing an inexpensive and portable means for connecting two electronic devices over a short distance.

To achieve the foregoing objective, the flat restorable cable has a cable body and two connectors.

The cable body is wound to take a spirally wound form, wherein the cable body is extended by pulling two ends of the cable and restores back to the spirally wound form once either end of the cable is released.

The two connectors are securely mounted to respective ends of the cable body.

The maximum thickness of the flat restorable cable is just the thickness of one of the two connectors having larger thickness and the outer diameter of the cable and the cable is about a palm size. Due to less part required, the cable is more inexpensive than the conventional retractable cable. Therefore, the cable of the present invention provides an inexpensive and portable solution to connect two electronic devices over a short distance.

### BRIEF DESCRIPTION OF THE DRAWINGS

FIG. 1 is a first perspective view of a flat restorable cable in accordance with the present invention;

FIG. 2 is a first top view of a flat restorable cable in accordance with the present invention;

FIG. 3 is a second top view of a flat restorable cable in accordance with the present invention;

FIG. 4 is another perspective view of the flat restorable cable in FIG. 1 when the cable is extended;

FIG. 5 is a perspective view of a conventional retractable cable;

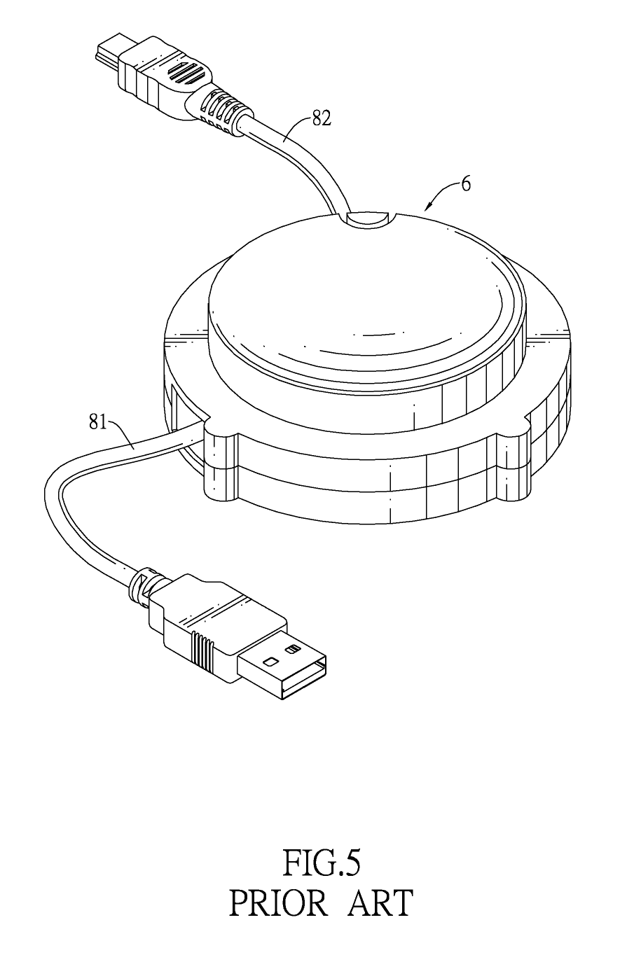

FIG. 6 is an exploded perspective view of the conventional retractable cable in FIG. 5; and

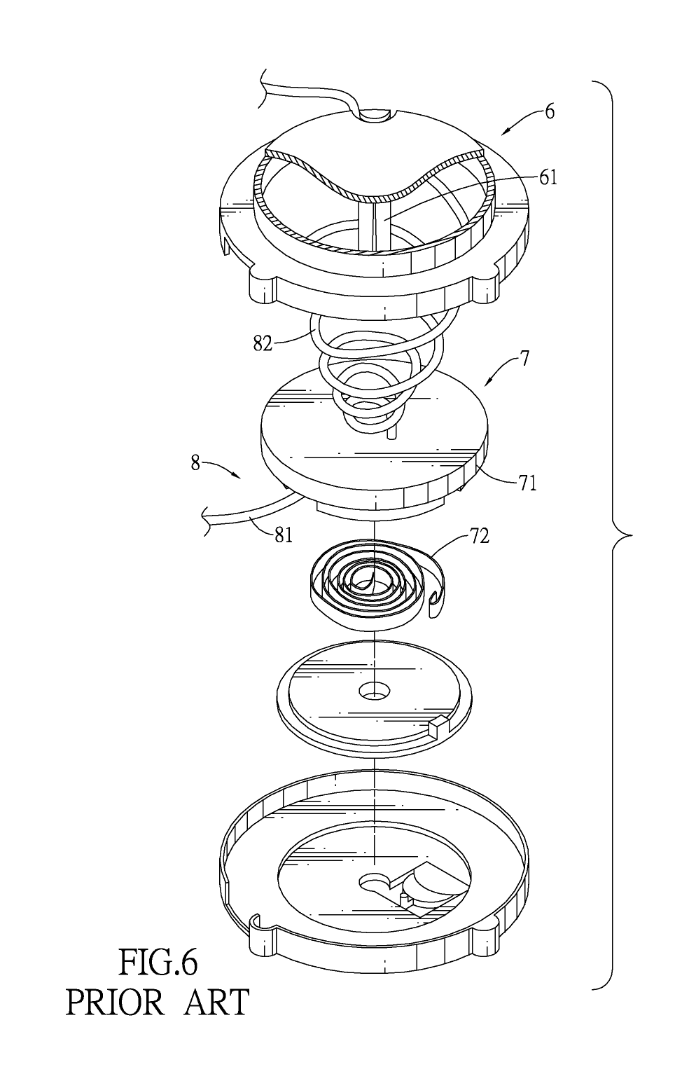

FIG. 7 is a perspective view of a conventional telephone handset cord.

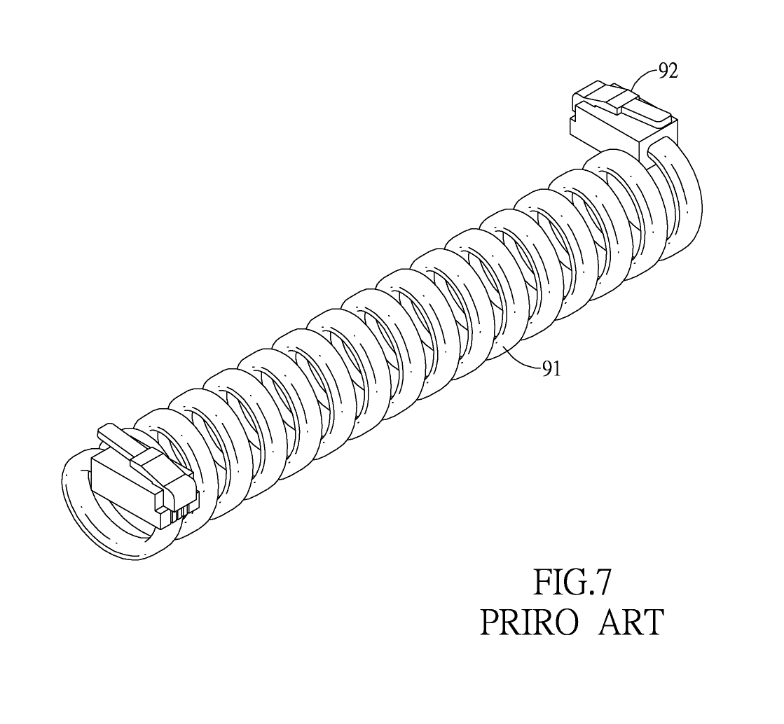

### DETAILED DESCRIPTION OF THE INVENTION

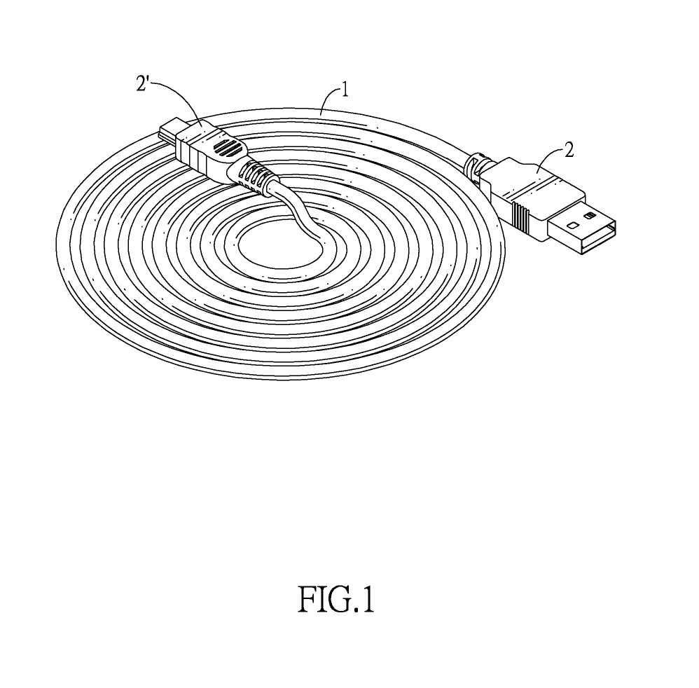

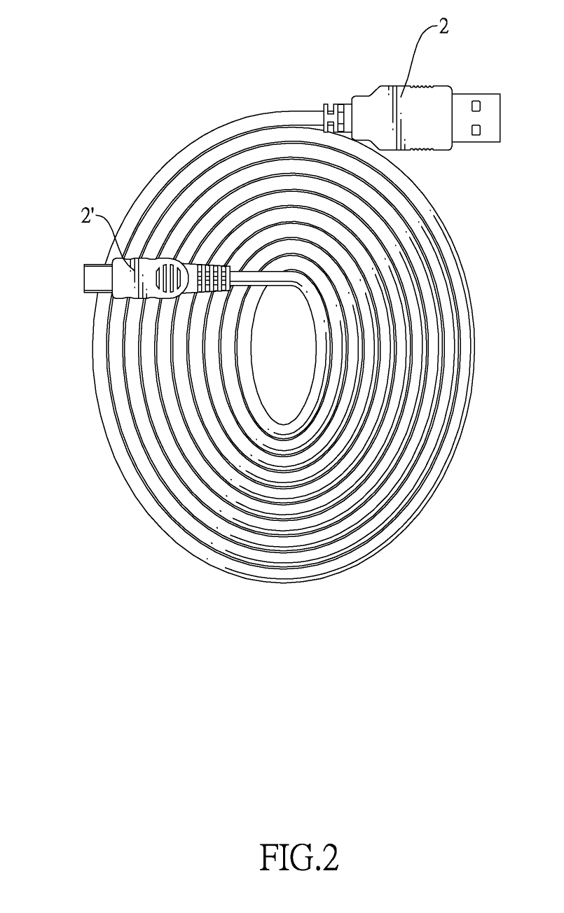

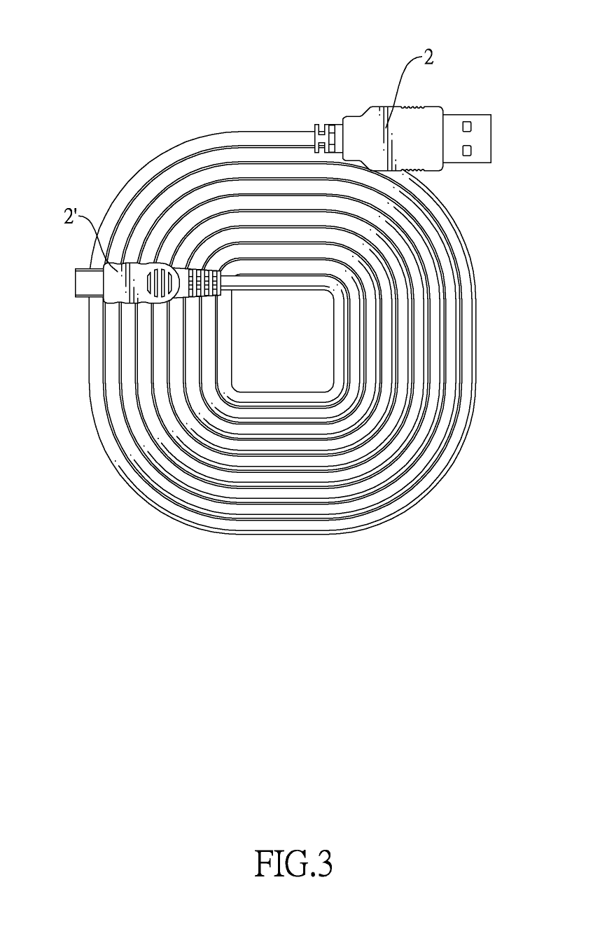

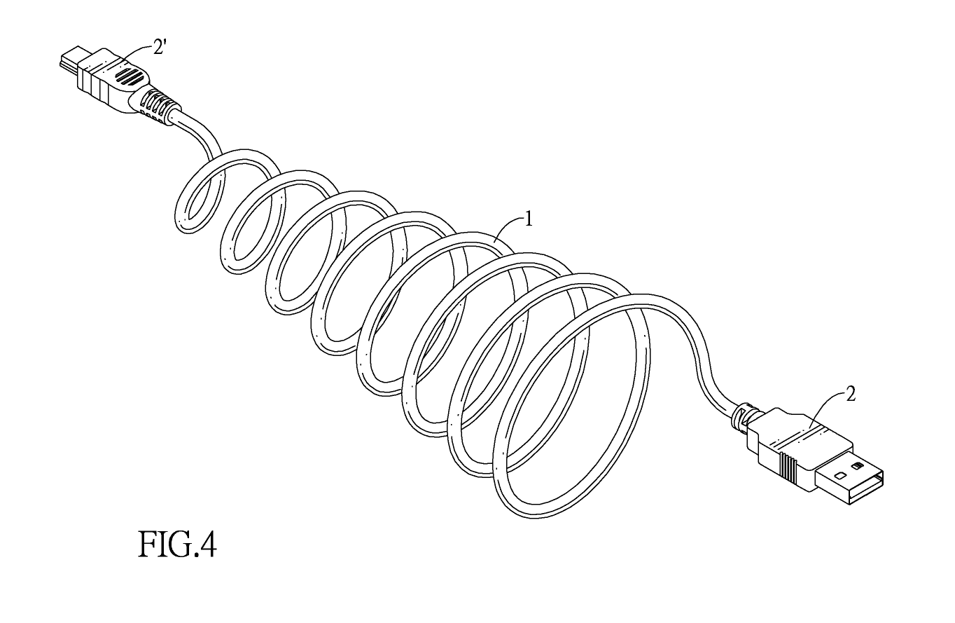

With reference to FIGS. 1 to 4, a flat restorable cable in accordance with the present invention has a cable body (1) and two connectors (2, 2′).

The cable body (1) is wound to have a spirally wound form, is extended by pulling two ends of the cable body (1), and restores back to the original spirally wound form once either end of the cable body (1) is released. The cable body (1) is flat in thickness and the spirally wound form may be circular, oval-like or square.

The two connectors (2, 2′) are securely mounted to respective ends of the cable body (1) and used to respectively connect with two external compatible interfaces. Certain portion of each connector (2)(2′) may be integrally formed with the cable body (1). Depending on the interfaces to be connected, the two connectors (2, 2′) can be both in male form, both in female form or one in male form and the other in female form. In consideration of types of the interfaces to be connected, the two connectors (2, 2′) may be of types selectively chosen from one or two types of USB, mini USB, macro USB, e-SATA, HDMI standards.

When the cable body (1) is fully restored to the original spirally wound shape, the thickness of the cable is no more than the total of the thickness of one of the two connectors (2, 2′) with a larger thickness and the outer diameter of the cable. The size of the restored cable should be able to be smoothly received in a pocket of a shirt or a pant.

To the extent that the cable body (1) is not broken, the cable body (1) can be extended as long as possible to connect with two interfaces of two electronic devices. After finishing the use of the cable, the cable can be disconnected from the connected electronic devices and restored to its original spirally wound shape by releasing either end of the cable.

Given the thin and compact size, the flat restorable cable of the present invention can be conveniently carried in a pocket of a shirt or a pant. In contrast to conventional retractable cables, the cost of the present invention is more inexpensive as a result of less part required. Accordingly, the flat restorable cable addresses an inexpensive and portable solution to connect two electronic devices having compatible interfaces with the connectors of the cable over a short distance.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A flat restorable cable, comprising:
a cable body wound to take a spirally wound form, wherein the cable body is extended by pulling two ends of the cable and restores back to the spirally wound form once either end of the cable is released; and
two connectors securely mounted to respective ends of the cable body.

2. The flat restorable cable as claimed in claim 1, wherein the spirally wound form is circular.

3. The flat restorable cable as claimed in claim 1, wherein the spirally wound form is oval-like.

4. The flat restorable cable as claimed in claim 1, wherein the spirally wound form is square.

5. The flat restorable cable as claimed in claim 2, wherein one of the two connectors is female type, and the other of the two connectors is male type.

6. The flat restorable cable as claimed in claim 2, wherein the two connectors are both female types.

7. The flat restorable cable as claimed in claim 2, wherein the two connectors are both male types.

8. The flat restorable cable as claimed in claim 5, wherein the female type connector is one of USB type socket, e-SATA socket and HDMI socket, and the male type connector is one of USB type plug, e-SATA plug and HDMI plug.

9. The flat restorable cable as claimed in claim 6, wherein either one of the two female type connectors is one of USB type socket, e-SATA socket and HDMI socket.

10. The flat restorable cable as claimed in claim 7, wherein either one of the two male type connectors is one of USB type plug, e-SATA plug and HDMI plug.

11. The flat restorable cable as claimed in claim 3, wherein one of the two connectors is female type, and the other of the two connectors is male type.

12. The flat restorable cable as claimed in claim 3, wherein the two connectors are both female types.

13. The flat restorable cable as claimed in claim 3, wherein the two connectors are both male types.

14. The flat restorable cable as claimed in claim 11, wherein the female type connector is one of USB type socket, e-SATA socket and HDMI socket, and the male type connector is one of USB type plug, e-SATA plug and HDMI plug.

15. The flat restorable cable as claimed in claim 12, wherein either one of the two female type connectors is one of USB type socket, e-SATA socket and HDMI socket.

16. The flat restorable cable as claimed in claim 13, wherein either one of the two male type connectors is one of USB type plug, e-SATA plug and HDMI plug.

17. The flat restorable cable as claimed in claim 4, wherein one of the two connectors is female type, and the other of the two connectors is male type.

18. The flat restorable cable as claimed in claim 4, wherein the two connectors are both female types.

19. The flat restorable cable as claimed in claim 4, wherein the two connectors are both male types.

20. The flat restorable cable as claimed in claim 17, wherein the female type connector is one of USB type socket, e-SATA socket and HDMI socket, and the male type connector is one of USB type plug, e-SATA plug and HDMI plug.
